(19) United States
(12) Patent Application Publication
(10) Pub. No.: US 2015/0004903 A1
(43) Pub. Date: Jan. 1, 2015

(54) Chipless Near Field-Communication for Mobile Devices

(71) Applicant: Nate Lyman, Livermore, CA (US)

(72) Inventor: Nate Lyman, Livermore, CA (US)

(21) Appl. No.: 13/931,406

(22) Filed: Jun. 28, 2013

(51) Int. Cl. H04W 4/00

(52) U.S. Cl. CPC H04W 4/008
USPC 455/41.1

(57) ABSTRACT

Techniques for chipless near field communication for mobile devices are described. According to various embodiments, it may be determined that a particular object has physically contacted a wireless access point device or is currently located within a predetermined distance of the wireless access point device. A passive listening mode of the wireless access point device may be activated. Thereafter, a probe request broadcast by a mobile device near the wireless access point device may be detected, and it may be determined that the mobile device is the particular object, based on the probe request. Further, a media access control address associated with the mobile device may be determined, based on the wireless access probe request. Moreover, a user of the mobile device may be determined, based on the media access control address associated with the mobile device.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to data processing systems and, in one specific example, to techniques for chipless near field communication for mobile devices.

### BACKGROUND

The near field communication (NFC) standard allows for the transfer of information between smartphones. In order for smartphones to transfer data based on the NFC standard, the smartphones must be equipped with specialized NFC hardware, such as an NFC chip or NFC tag.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed;

FIG. 2 is a block diagram of an example system, according to various embodiments;

FIG. 3 is a flowchart illustrating an example method, according to various embodiments;

FIG. 4 illustrates an example of MAC address information, according to various embodiments;

FIG. 5 illustrates an example of user action information, according to various embodiments;

FIG. 6 is a flowchart illustrating an example method, according to various embodiments;

FIG. 7 is a flowchart illustrating an example method, according to various embodiments;

FIG. 8 is a flowchart illustrating an example method, according to various embodiments;

FIG. 9 is a flowchart illustrating an example method, according to various embodiments;

FIG. 10 is a flowchart illustrating an example method, according to various embodiments;

FIG. 11 illustrates an exemplary mobile device, according to various embodiments; and

FIG. 12 is a diagrammatic representation of a machine in the example form of a computer system within which a set of instructions, for causing the machine to perform any one or more of the methodologies discussed herein, may be executed.

### DETAILED DESCRIPTION

Example methods and systems for chipless near field communication for mobile devices are described. In the following description, for purposes of explanation, numerous specific details are set forth in order to provide a thorough understanding of example embodiments. It will be evident, however, to one skilled in the art that the present invention may be practiced without these specific details.

According to various exemplary embodiments described herein, when a user taps or touches their mobile device against a wireless access point (WAP) device, or when the user brings the mobile device in close proximity to the WAP device, the WAP device is configured to identify the user and to perform a predefined action, even if the mobile device of the user does not include a near field communication (NFC) chip. While the conventional NFC standard allows smartphones to be paired with each other when the smart phones are brought into physical contact with each other, the NFC standard requires smartphones to be outfitted with special NFC hardware, such as NFC chips or NFC tags. However, a large portion of smartphones available today (including smartphones provided by Apple®) do not include the special NFC hardware and do not support the NFC standard. Accordingly, various embodiments described throughout allow almost any mobile device to communicate in a similar manner to the NFC standard, without the requirement for a special NFC hardware to be installed in the mobile device.

According to various exemplary embodiments, a WAP device may be attached to a point of sale terminal, vending machine, a door lock, or various other devices. When the WAP device senses that it has been touched or moved slightly by an external object, or when the WAP device senses that an object is located within close proximity of the WAP device, the WAP device may activate a passive listening mode to detect if a wireless device is in range and, if so, the WAP device may access the media access control (MAC) address associated with the wireless device. Thereafter, the WAP device may correlate this MAC address to a user of the wireless device, and perform some predefined action associated with the user, such as completing a transaction at a point-of-sale terminal, completing a purchase at a vending machine, locking or unlocking a door lock mechanism, and so on.

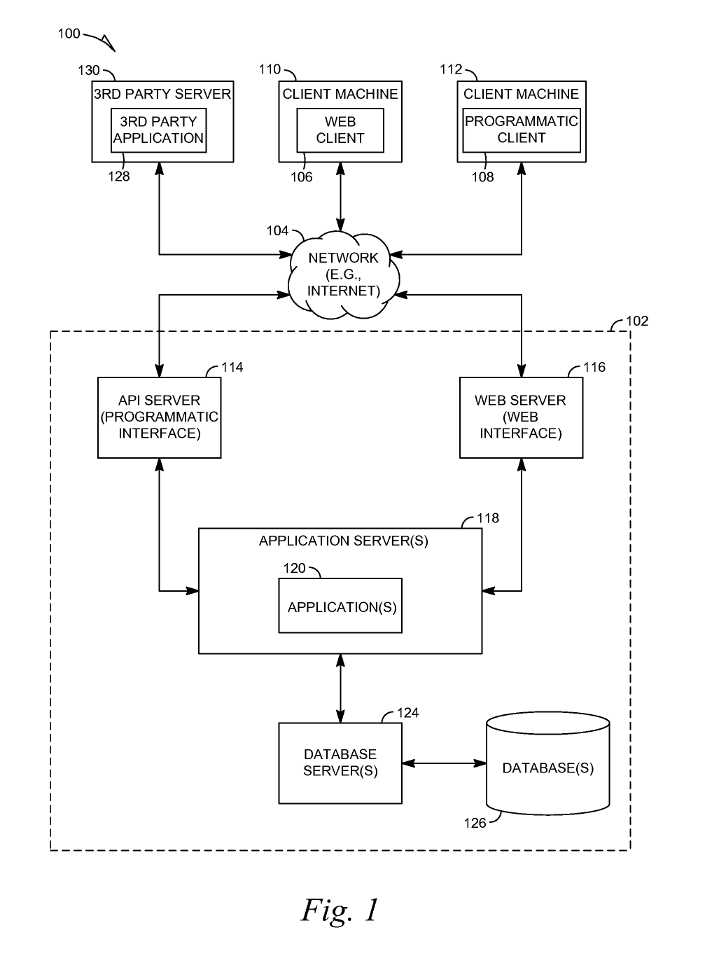

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

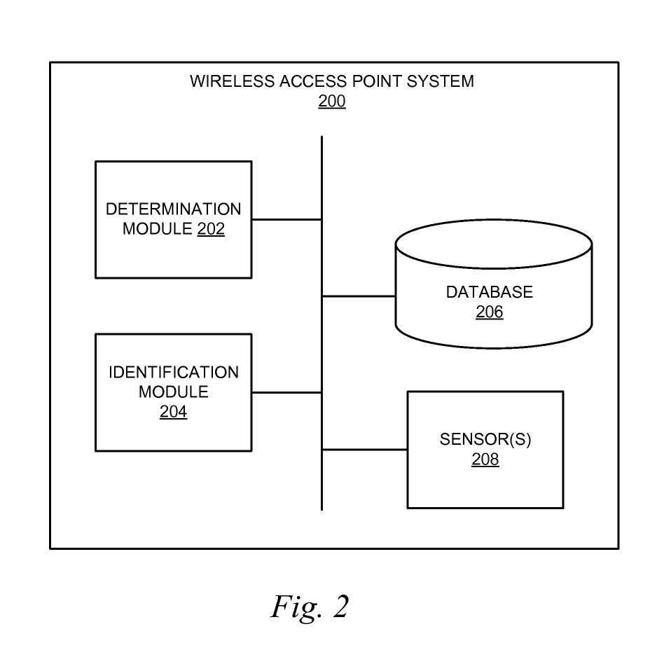

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may be implemented on or executed by one or more of the modules of the system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

Turning now to FIG. 2, a wireless access point (WAP) system 200 includes a determination module 202, an identification module 204, a database 206, and one or more sensors 208. The modules of the WAP system 200 may be implemented on or executed by a single device (e.g., one of the client machines (e.g. 110, 112) or application server(s) 118 illustrated in FIG. 1), or on separate devices interconnected via a network. In various embodiments described throughout, one or more modules of the WAP system 200 may be included in, implemented by, or executed on a WAP device. As understood by those skilled in the art of computer networking, a WAP device (also referred to as an access point (AP)) is a specially configured node on a wireless local area network (WLAN), which acts as a central transmitter and receiver of WLAN radio signals. A WAP device bridges a WLAN with a wired networks such as a Ethernet local area network (LAN), in that it allows various wireless devices (e.g., personal computers, smartphones, tablets, laptop computers, etc.) to connect to the wired network, typically using Wi-Fi communications standards based on the IEEE 802.11 standard. The WAP device usually connects to a router (via a wired network) as a standalone, dedicated hardware device featuring a built-in network adapter, antenna, and radio transmitter. Alternatively, the WAP device can also be integrated with other components such as a router, ethernet switch, etc., in the form of an integrated device. WAP devices are widely available from manufacturers such as Cisco®, Dell®, Netgear®, D-Link® and so on.

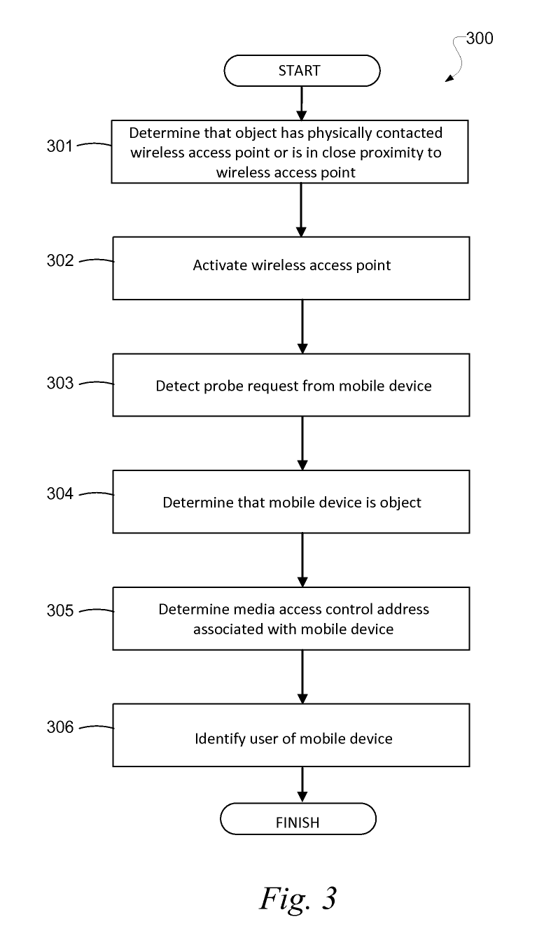

According to various exemplary embodiments described in more detail below, the determination module 202 of the WAP system 200 is configured to determine that a particular object has physically contacted a wireless access point device (e.g., the WAP system 200), and to activate a passive listening mode of the WAP system 200 in response to the detected physical contact. Moreover, while in the passive listening mode, the determination module 202 is configured to detect a wireless access probe request broadcast by a mobile device, and to determine that the mobile device that transmitted the probe request is the particular object that physically contacted the WAP system 200. Thereafter, the identification module 204 of the WAP system 200 is configured to determine a media access control (MAC) address associated with the mobile device, and to identify a user of the mobile device, based on the MAC address. The operation of the aforementioned modules of the WAP system 200 will now be described in greater detail in conjunction with FIG. 3.

FIG. 3 is a flowchart illustrating an example method 300, according to various exemplary embodiments. The method 300 may be performed at least in part by, for example, the WAP system 200 illustrated in FIG. 2 (or an apparatus having similar modules, such as client machines 110 and 112 or application server 118 illustrated in FIG. 1). In operation 301, the determination module 202 determines that a particular object has physically contacted a WAP device (e.g., the WAP system 200) and/or has come within close proximity of (e.g., is currently located within a predetermined distance of) the WAP device. For example, in some embodiments, the WAP system 200 may include one or more sensors 208 such as accelerometers and gyroscopes configured to detect movement in the position of the WAP system 200. Thus, based on input from such sensors 208, the determination module 202 may determine that the WAP system 200 has been touched or moved, and thus has come into physical contact with another object. Instead, or in addition, the sensors 208 may include an audio sensor, a rangefinder, a motion detection sensor, or other sensors configured to detect if an object is moved to within close proximity (e.g., less than 1 meter) of the WAP system 200, or to detect if the object is located close enough to the WAP system 200 that it has come into physical contact with the WAP system 200.

In operation 302, in response to determining that an object has physically contacted the WAP system 200 and/or has come within close proximity of (e.g., is currently located within a predetermined distance of) the WAP system 200, the determination module 202 activates a passive listening mode of the WAP system 200. In other words, the trigger for the initiation of the passive listening mode of the WAP system 200 is when an object is touched against the WAP system 200 and/or is brought to within a predetermined range of the WAP system 200. While operating in the passive listening mode, the WAP system 200 is configured to detect wireless access probe requests transmitted by nearby mobile devices, as described in more detail below.

As understood by those skilled in the art, a passive listening mode (also referred to as a passive scan mode, passive mode, or listening mode) of an access point is a mode in which the access point listens and detects information that is broadcast by nearby client stations (e.g., mobile devices). For example, as understood by those skilled in the art, network interface cards (NICs) of client stations broadcast various types frames of information in accordance with the 802.11 wireless standard, including a probe request frame (also referred to throughout as a wireless access probe request). A probe request frame is a special type of WLAN frame sent by a client station requesting information from either a specific access point, or all access points in the area. More specifically, a client station sends a probe request frame to determine which access points are within range and to obtain information from these access points. Probe requests may be transmitted by a client stations while they are operating in an active scan mode themselves, e.g. when they are performing an active scan of either a specific network or all networks in the area by actively sending probe requests and requesting all nearby access points to announce their presence. The probe request may include information describing the client station, such as a media access control (MAC) address of a NIC of the client station. The information being requested in the probe request includes the data rates supported by the access point, and various other information required to establish a communication session between the station and the access point. Accordingly, the access point operating in passive scan mode may detect all of the nearby wireless networks based on a passive scan, such that the access point may remain completely silent without sending out any data, and the data compiled is done so only using probe requests freely available over a network.

Typically when an access point operating in a passive scan mode detects a probe request frame, either directed at the specific access point or to all access points in the area, it will send out a probe response frame containing capability information, station parameters, supported data rates, etc. After the client station receives the probe response, the client station may utilize the information in the probe response to determine whether a connection with the access point should be established. In the method 300 in FIG. 3, it is not necessary for the WAP system 200 to output a probe response frame in response to the probe request received in operation 303.

Accordingly, with reference to the method 300 in FIG. 3, after the determination module 202 activates a passive listening mode in operation 302, the determination module 202 is configured to detect a wireless access probe request broadcast by a mobile device in operation 303. In operation 304, the determination module 202 determines, based on the wireless access probe request, that the mobile device that transmitted the probe request is the particular object that physically contacted the WAP system 200 (or was brought within close proximity of the WAP system 200). For example, the determination module 202 may make this determination by default, if the determination module 202 only detects one or more probe requests from a single mobile device (e.g., one or more probe requests including the same MAC address). In some embodiments, if the determination module 202 detects one or more probe requests from multiple mobile devices, the determination module 202 may determine a proximity of each of the mobile devices to the WAP system 200, based on a signal strength of the wireless access probe request (where stronger signal strength of a wireless access probe request typically indicates that the source client or mobile device is closer to the WAP system 200). Accordingly, the determination module 202 may confirm that the mobile device is the particular object that physically contacted the WAP system 200 (or was brought within close proximity of the WAP system 200), based on the determined proximity. For example, if multiple probe requests are received from multiple mobile devices, the determination module 202 may determine that the probe request having the strongest signal strength originates from the mobile device that is closest to the WAP system 200, and thus the determination module 202 may determine that this mobile device is the object that physically contacted the WAP system 200 (or was brought within close proximity of the WAP system 200).

In operation 305 in FIG. 3, the determination module 202 determines a media access control address associated with the mobile device, based on the wireless access probe request. For example, wireless access probe requests or probe request frames typically include the MAC address of the NIC of the client that transmitted the probe request. Thus, the determination module 202 may extract the MAC address from the probe request received in operation 303.

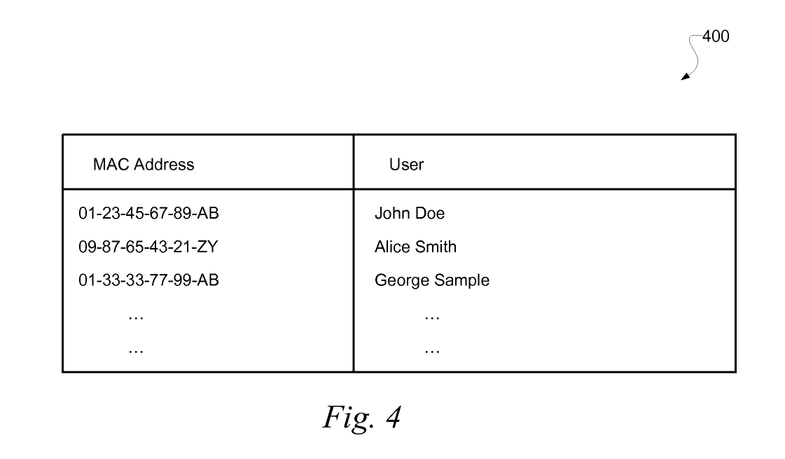

In operation 306 in FIG. 3, the identification module 204 identifies a user of the mobile device, based on the MAC address associated with the mobile device. For example, the identification module 204 may access MAC address information identifying a plurality of users and a corresponding plurality of MAC addresses of devices associated with these users. FIG. 4 illustrates an example of MAC address information 400 identifying various users, such as John Doe, Alice Smith, George Sample, and so on, as well as MAC addresses of devices corresponding to each of the users. The MAC address information 400 may be stored locally at, for example, the database 206 illustrated in FIG. 2, or may be stored remotely at a database, data repository, storage server, etc., that is accessible by the WAP system 200 via a network (e.g., the Internet).

The aforementioned MAC address information may be generated by the WAP system 200 or another device in various ways. For example, a mobile application installed on a mobile device may be configured to collect and maintain user information describing a user of the mobile device, including user name, user contact information (e.g., phone number, e-mail address), user financial account information, and so on. For example, the mobile application may be associated with a retailer, business, marketplace website (e.g., eBay®), financial institution or a financial payment service (e.g., PayPal®, a bank), and so on, and the mobile application may request user permission (e.g., based on an opt in system) to upload various information about the user to a remote server to be assembled into the aforementioned MAC address information 400. If the user agrees, the mobile application may prompt the user to enter login or authentication information for a user account that the user has with the retailer, business, marketplace website, financial institution, financial payment service, etc., and the mobile application may access the various user information from the user account of the user. The mobile application may also be configured to detect a MAC address of the mobile device, such as by accessing configuration files or system files of the mobile device that are stored in memory of the mobile device. Thereafter, the mobile application may transmit the user information describing the user and MAC address of the mobile device to a remote server, which may collect this information and assemble it into the aforementioned MAC address information 400. Although not illustrated in FIG. 4, the MAC address information 400 may include user contact information associated with the user, user financial information associated with the user, user preference information associated with the user, user history information associated with the user, and so on.

According to various exemplary embodiments, the passive listening mode activated in operation 302 may be a low-power or reduced power passive listening mode of the WAP system 200. For example, the WAP system 200 may include both a regular power passive listening mode (where the WAP system 200 may detect probe requests transmitted by clients located a further distance from the WAP system 200), as well as a low-power or reduced power passive listening mode (where the WAP system 200 may detect wireless access probe requests from mobile devices located within a closer specific distance of the WAP system 200). By operating in the low-power or reduced power passive listening mode, the WAP system 200 may avoid being inundated with probe requests from all mobile devices within a large range of the WAP system 200 (e.g., all mobile devices in the same room or the same building floor as the WAP system 200). Accordingly, the WAP system 200 may more easily identify the mobile device that physically contacted the WAP system 200, since the WAP system 200 will only be receiving probe requests from nearby mobile devices. This also improves the security and safety of both the WAP system 200 and the other mobile devices.

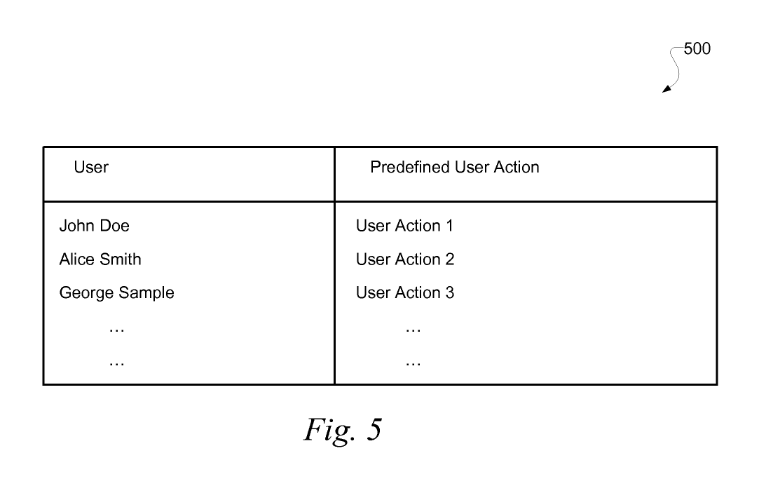

According to various exemplary embodiments, once the user associated with a mobile device is identified in the manner described above (e.g., see operation 306 in FIG. 3), the WAP system 200 may cause a predefined action for that user to be performed. For example, the identification module 204 may access user action information identifying predefined actions associated with various users. For example, FIG. 5 illustrates exemplary user action information 500 identifying various users (e.g., John Doe, Alice Smith, George Sample, etc.) and a predefined user action associated with each of the users (e.g., user action 1, user action 2, etc.). Accordingly, if the identification module 204 determines that the particular user identified in operation 306 (see FIG. 3) is included in the user action information 500, the identification module 204 may cause the predefined user action associated with that particular user to be performed. As described in more detail below, the user action may be any one of various actions such as transmitting a message to the user, establishing a pairing connection between the WAP system 200 and the mobile device of the user, transferring information between the WAP system 200 or a third-party device and the mobile device of the user, locking or unlocking access to content, locking or unlocking a physical locking mechanism, performing a financial transaction, causing personalized content to be displayed to the user, and so on. In some embodiments, one or more of the user actions in the user action information 500 may be similar or identical. In some embodiments, the user action information 500 may correspond to an access control list (ACL), in that if the identification module 204 does not detect the particular user in the user action information 500, the identification module 204 prevents one or more particular user actions from being performed.

In some embodiments, if the identification module 204 identifies a particular user in the user action information 500, the identification module 204 may transmit a notification to the user requesting user approval to perform the predefined action, and if the identification module 204 receives an appropriate response with approval from the user, the identification module 204 may perform the predefined action. The aforementioned notification may be, for example, an e-mail message, text message, an alert displayed in an operating system user interface of the mobile device, a pop-up window displayed by mobile application installed on the user's mobile device, a pop-up window displayed in a web browser installed on the user's mobile device, and so on. The identification module 204 may transmit the aforementioned notification based on user contact information associated with the user that is included in the MAC address information 400.

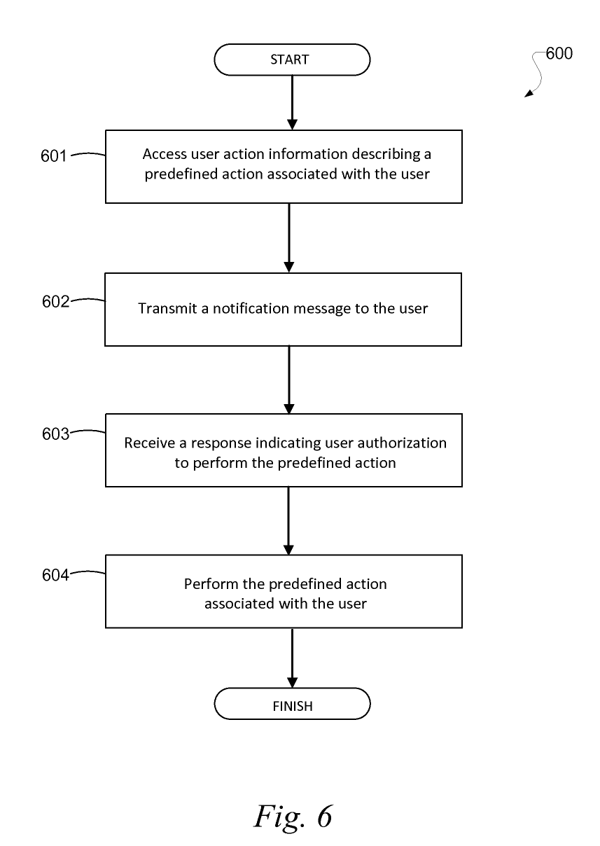

FIG. 6 is a flowchart illustrating an example method 600, consistent with various embodiments described above. The method 600 may be performed at least in part by, for example, the WAP system 200 illustrated in FIG. 2 (or an apparatus having similar modules, such as client machines 110 and 112 or application server 118 illustrated in FIG. 1). The method 600 may be performed after, for example, the method 300 illustrated in FIG. 3. In operation 601, the identification module 204 accesses user action information describing a predefined action associated with the user (who was identified in operation 306 in FIG. 3). In operation 602, the identification module 204 transmits a notification message to the user, the notification message requesting user authorization to perform the predefined action. In operation 603, the identification module 204 receives a response indicating user authorization to perform the predefined action. In operation 604, the identification module 204 performs the predefined action associated with the user. In some embodiments, operations 602 and 603 in the method 600 may be omitted.

Accordingly, whereas various existing communication systems operating in accordance with the near field communication (NFC) standard require mobile devices to be installed with specific hardware, various embodiments described throughout allow mobile devices to communicate in a similar manner to the NFC protocol, without the requirement for a specific NFC hardware to be installed. Thus, by simply having a regular 802.11 wireless card or network interface card installed on a mobile device (which is the case for almost every mobile device manufactured today), the user may simply touched their mobile device against a WAP device, in order for the WAP system 200 to identify the user and to perform some predefined user action for the user, such as transmitting a message to the user, establishing a pairing connection between the WAP system 200 and mobile device of the user, transferring information between the WAP system 200 or a third-party device and the mobile device of the user, locking or unlocking access to content, locking or unlocking a physical locking mechanism, performing a financial transaction, causing personalized content to be displayed to the user, and so on. This is particularly advantageous since the NFC protocol is not supported on a large number of smartphones (e.g., smartphones manufactured by Apple®).

In some embodiments, the WAP system 200 of this disclosure may be utilized to allow a user to operate a locking mechanism (e.g., locking or unlocking a door locking mechanism or a safe locking mechanism), simply by touching their mobile phone against the WAP system 200. For example, in some embodiments, one or more modules of the WAP system 200 may be attached to a locking mechanism or may be integrated into a physical structure of a locking mechanism. After the identification module 204 identifies a user of a mobile device that physically contacts the WAP system 200 (see operation 306 in FIG. 3), the identification module 204 may determine if the user is authorized to operate (e.g., open or close) the locking mechanism. For example, the identification module 204 may access an access control list (ACL) associated with the lock mechanism that identifies various authorized users of the locking mechanism, in order to determine if a particular user is authorized to control the lock mechanism. In some embodiments, the ACL may correspond to the user action information 500 illustrated in FIG. 5. In some embodiments, the identification module 204 may transmit a notification to the user requesting user approval to operate the locking mechanism, or requesting user instructions to operate the locking mechanism (e.g., open or close), and if the identification module 204 receives an appropriate response from the user, the identification module 204 may operate the locking mechanism appropriately (e.g., the identification module 204 activates or deactivates the lock mechanism, based on the response). The aforementioned notification may be, for example, an e-mail message, text message, an alert displayed in an operating system user interface of the mobile device, a pop-up window displayed by mobile application installed on the user device, a pop-up window displayed in a web browser installed on the user's mobile device, and so on. The identification module 204 may transmit the aforementioned notification based on user contact information associated with the user that is included in the MAC address information 400.

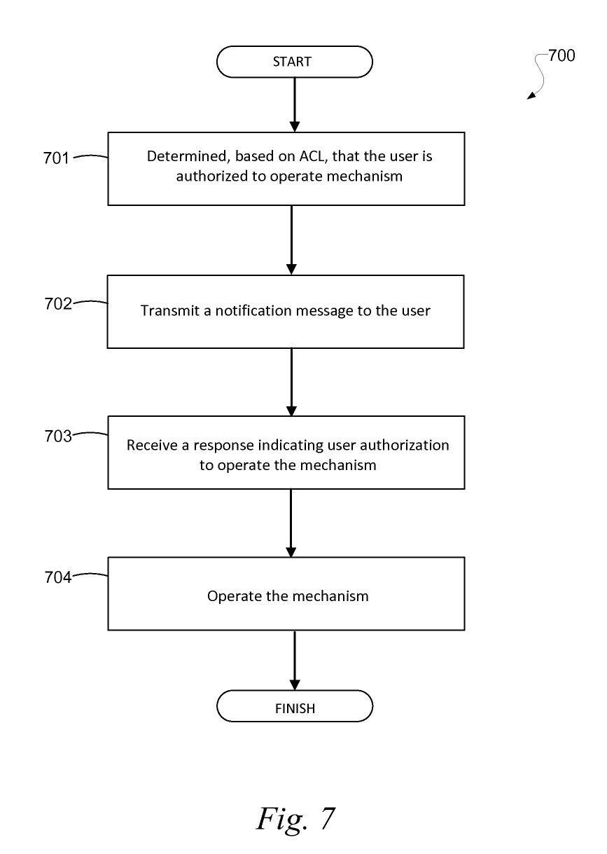

FIG. 7 is a flowchart illustrating an example method 700, consistent with various embodiments described above. The method 700 may be performed at least in part by, for example, the WAP system 200 illustrated in FIG. 2 (or an apparatus having similar modules, such as client machines 110 and 112 or application server 118 illustrated in FIG. 1) associated with a lock mechanism, such as a door lock mechanism or safe lock mechanism. The method 700 may be performed after, for example, the method 300 illustrated in FIG. 3. In operation 701, the identification module 204 determines, based on an access control list associated with the lock mechanism, that a user (e.g., the user identified in operation 306 in FIG. 3) is authorized to control a lock mechanism. In operation 702, the identification module 204 transmits a notification message to the user, the notification message requesting user authorization to activate or deactivate the lock mechanism. In operation 703, the identification module 204 receives a response indicating user authorization to activate or deactivate the lock mechanism. In operation 704, the identification module 204 activates or deactivates the lock mechanism, based on the response received in operation 703.

In some embodiments, the WAP system 200 of this disclosure may be utilized to allow a user to perform a financial transaction (e.g., purchasing a product from a vending machine or purchasing a product at a point-of-sale terminal), simply by touching their mobile phone against the WAP system 200. For example, in some embodiments, one or more modules of the WAP system 200 may be attached to a vending machine or point-of-sale terminal, or may be integrated into a physical structure of a vending machine or point-of-sale terminal. In some embodiments, after the identification module 204 identifies a user of a mobile device that physically contacts the WAP system 200 (see operation 306 in FIG. 3), the identification module 204 may access financial account information associated with the user, such as credit card information of the user, bank account information (e.g., current number, routing number, etc.) associated with the user, electronic payment account information (e.g., PayPal account information) associated with the user, etc. In some embodiments, if the user touches the mobile device against a WAP device installed on a vending machine, then the identification module 204 may transmit a notification to the user requesting user selection of one of the product items for sale in the vending machine and/or requesting user confirmation of financial account information (e.g., PayPal account number, PayPal account e-mail address, credit card information). If the identification module 204 receives a response with a selection from the user, the identification module 204 may complete the transaction based on the financial account information for the user. In some embodiments, if a product items already been selected by the user based on selection buttons of the vending machine, then the identification module 204 may transmit a notification to the user requesting user approval to purchase the product item and/or requesting user confirmation of financial account information (e.g., PayPal account number, PayPal account e-mail address, credit card information), and if the identification module 204 receives an appropriate response with approval from the user, the identification module 204 may complete the transaction based on the financial account information for the user. In some embodiments, if a product item selected by the user has been scanned at the point-of-sale terminal, then the identification module 204 may transmit a notification to the user requesting user approval to purchase the product item and/or requesting user confirmation of financial account information (e.g., PayPal account number, PayPal account e-mail address, credit card information), and if the identification module 204 receives an appropriate response with approval from the user, the identification module 204 may complete the transaction based on the financial account information for the user. Any of the aforementioned notifications may be, for example, an e-mail message, text message, an alert displayed in an operating system user interface of the mobile device, a pop-up window displayed by mobile application installed on the user device, a pop-up window displayed in a web browser installed on the user's mobile device, and so on. The identification module 204 may transmit the aforementioned notification based on user contact information associated with the user that is included in the MAC address information 400.

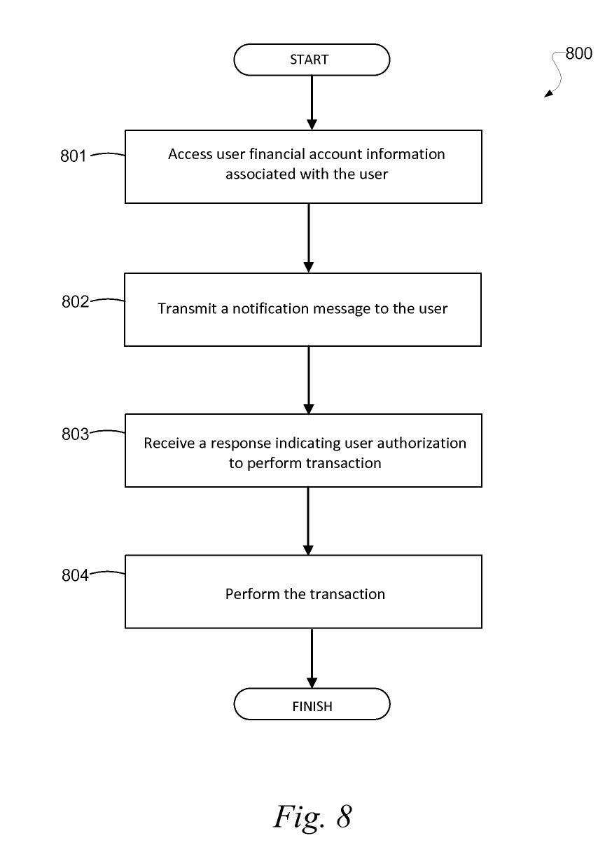

FIG. 8 is a flowchart illustrating an example method 800, consistent with various embodiments described above. The method 800 may be performed at least in part by, for example, the WAP system 200 illustrated in FIG. 2 (or an apparatus having similar modules, such as client machines 110 and 112 or application server 118 illustrated in FIG. 1) associated with a vending machine or point-of-sale terminal. The method 800 may be performed after, for example, the method 300 illustrated in FIG. 3. In operation 801, the identification module 204 accesses user financial account information associated with a user (e.g., the user identified in operation 306 in FIG. 3). In operation 802, the identification module 204 transmits a notification message to the user, the notification message requesting user authorization to perform a transaction based on the user financial account information at a vending machine or point-of-sale terminal. In operation 803, the identification module 204 receives a response indicating user authorization to perform the transaction based on the user financial account information at the vending machine or point-of-sale terminal. In operation 804, the identification module 204 performs the transaction, based on the response received in operation 802. In some embodiments, operations 802 and 803 in the method 800 may be omitted.

In some embodiments, the WAP system 200 of this disclosure may be utilized to allow a user to transfer information between a kiosk terminal or another computing device, simply by touching their mobile phone against the WAP system 200. For example, in some embodiments, one or more modules of the WAP system 200 may be attached to a kiosk terminal, or may be integrated into a physical structure of a kiosk terminal. In some embodiments, after the identification module 204 identifies a user of a mobile device that physically contacts the WAP system 200 (see operation 306 in FIG. 3), then the identification module 204 may transmit a notification to the user requesting user approval to transfer content (e.g., between the kiosk terminal or other computing device and the user's mobile device). In some embodiments, the notification may also include a request for a user selection of content for transfer (e.g., content installed on mobile device of the user or content accessible via the kiosk terminal or other computing device). Alternatively, the contents may have been selected by the user via a user interface of the kiosk device or other computing device. If the identification module 204 receives a response from the user with a selection of content and/or user approval for the transfer of content, the identification module 204 may proceed to pair the user's mobile device with the kiosk terminal, via a Wi-Fi network, Bluetooth connection, or any other known standard, and to proceed to share the content. The aforementioned notification may be, for example, an e-mail message, text message, an alert displayed in an operating system user interface of the mobile device, a pop-up window displayed by mobile application installed on the user device, a pop-up window displayed in a web browser installed on the user's mobile device, and so on. The identification module 204 may transmit the aforementioned notification based on user contact information associated with the user that is included in the MAC address information 400. In some embodiments, the identification module 204 may determine if the user is authorized to transfer content with the kiosk terminal. For example, the identification module 204 may access an access control list (ACL) associated with the kiosk terminal that identifies various authorized users of the kiosk terminal, in order to determine if a particular user is authorized to share content with the kiosk terminal. In some embodiments, the ACL may correspond to the user action information 500 illustrated in FIG. 5.

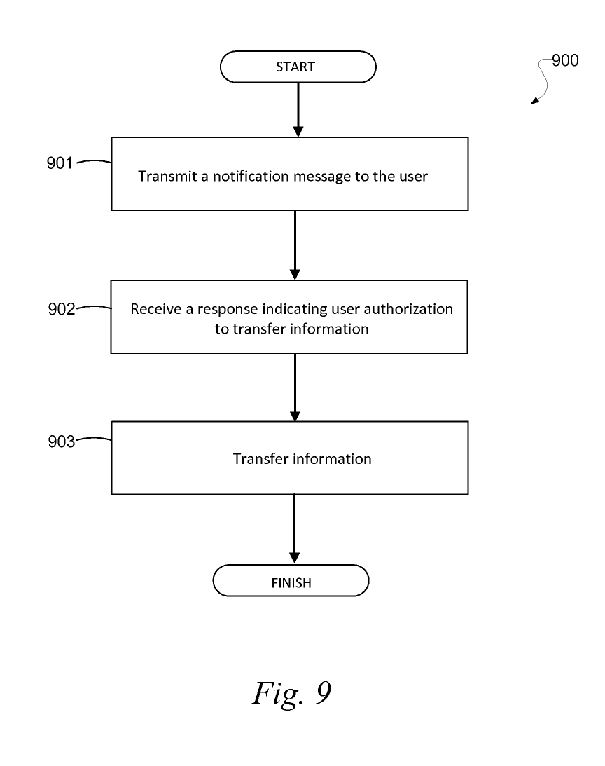

FIG. 9 is a flowchart illustrating an example method 900, consistent with various embodiments described above. The method 900 may be performed at least in part by, for example, the WAP system 200 illustrated in FIG. 2 (or an apparatus having similar modules, such as client machines 110 and 112 or application server 118 illustrated in FIG. 1) with a kiosk or another computing device (e.g., personal computer, laptop, tablet, smartphone, etc.). The method 900 may be performed after, for example, the method 300 illustrated in FIG. 3. In operation 901, the identification module 204 transmits a notification message to a user (e.g., the user identified in operation 306 in FIG. 3), the notification message requesting user authorization to transfer information between the mobile device and any one of the kiosk and the computing device. In operation 902, the identification module 204 receives a response indicating user authorization to transfer the information between the mobile device and any one of the kiosk and the computing device. In operation 903, the identification module 204 transfers the information between the mobile device and any one of the kiosk and the computing device, based on the response received in operation 902.

In some embodiments, the WAP system 200 of this disclosure may be utilized to allow a user to view personalized content on a kiosk terminal, simply by touching their mobile phone against the WAP system 200. For example, in some embodiments, one or more modules of the WAP system 200 may be attached to a kiosk terminal, or may be integrated into a physical structure of a kiosk terminal. In some embodiments, after the identification module 204 identifies a user of a mobile device that physically contacts the WAP system 200 (see operation 306 in FIG. 3), then the identification module 204 may access user history information or user preference information associated with the user. For example, the user history information or user preference information may be stored locally at, for example, the database 206 illustrated in FIG. 2, or may be stored remotely at a database, data repository, storage server, etc., that is accessible by the WAP system 200 via a network (e.g., the Internet). The identification module 204 may then select personalized content (e.g., news, articles, videos, images, coupons, advertisements, product catalogs, etc.) based on the user history information or user preference information, and cause the personalized content to be displayed via a user interface of the kiosk terminal. In some embodiments, the identification module 204 may determine if the user is authorized to view content on the kiosk terminal. For example, the identification module 204 may access an access control list (ACL) associated with the kiosk terminal that identifies various authorized users of the kiosk terminal, in order to determine if a particular user is authorized to view content on the kiosk terminal. In some embodiments, the ACL may correspond to the user action information 500 illustrated in FIG. 5.

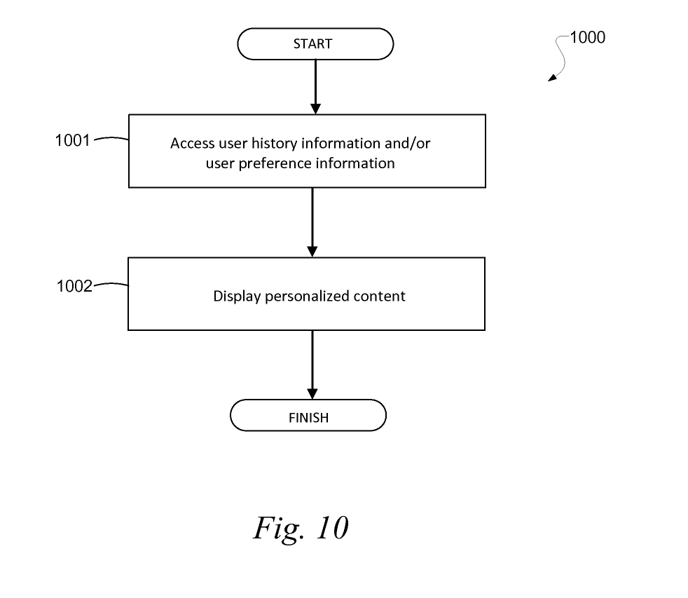

FIG. 10 is a flowchart illustrating an example method 1000, consistent with various embodiments described above. The method 1000 may be performed at least in part by, for example, the WAP system 200 illustrated in FIG. 2 (or an apparatus having similar modules, such as client machines 110 and 112 or application server 118 illustrated in FIG. 1) associated with a kiosk or another computing device (e.g., personal computer, laptop, tablet, smartphone, etc.). The method 1000 may be performed after, for example, the method 300 illustrated in FIG. 3. In operation 1001, the identification module 204 accesses user history information or user preference information associated with a user (e.g., the user identified in operation 306 in FIG. 3). In operation 1002, the identification module 204 displays personalized content on any one of a kiosk or another computing device, based on the user history information or user preference information.

### Example Mobile Device

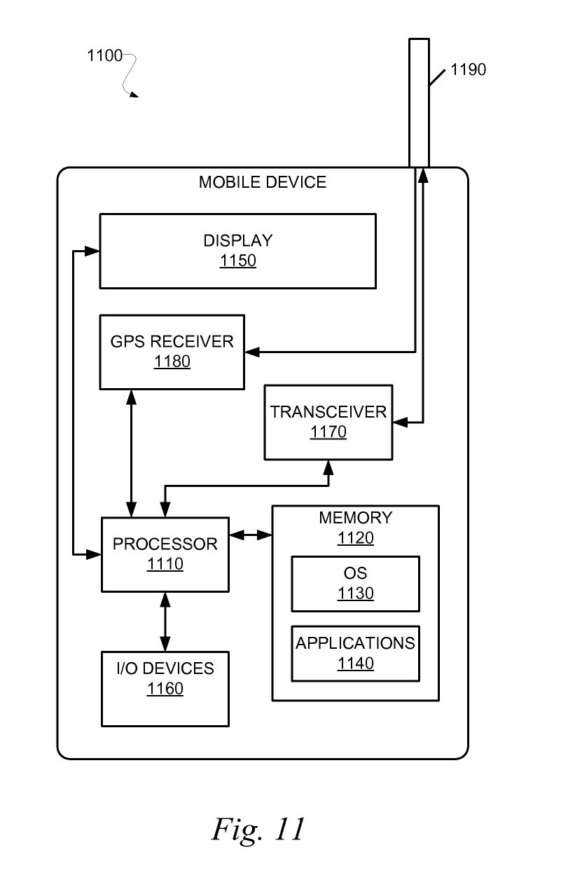

FIG. 11 is a block diagram illustrating the mobile device 1100, according to an example embodiment. The mobile device may correspond to, for example, client machines 110 and 112 or application server 118 illustrated in FIG. 1. One or more of the modules of the system 200 illustrated in FIG. 2 may be implemented on or executed by the mobile device 1100. The mobile device 1100 may include a processor 1110. The processor 1110 may be any of a variety of different types of commercially available processors suitable for mobile devices (for example, an XScale architecture microprocessor, a Microprocessor without Interlocked Pipeline Stages (MIPS) architecture processor, or another type of processor). A memory 1120, such as a Random Access Memory (RAM), a Flash memory, or other type of memory, is typically accessible to the processor 1110. The memory 1120 may be adapted to store an operating system (OS) 1130, as well as application programs 1140, such as a mobile location enabled application that may provide location based services to a user. The processor 1110 may be coupled, either directly or via appropriate intermediary hardware, to a display 1150 and to one or more input/output (I/O) devices 1160, such as a keypad, a touch panel sensor, a microphone, and the like. Similarly, in some embodiments, the processor 1110 may be coupled to a transceiver 1170 that interfaces with an antenna 1190. The transceiver 1170 may be configured to both transmit and receive cellular network signals, wireless data signals, or other types of signals via the antenna 1190, depending on the nature of the mobile device 1100. Further, in some configurations, a GPS receiver 1180 may also make use of the antenna 1190 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

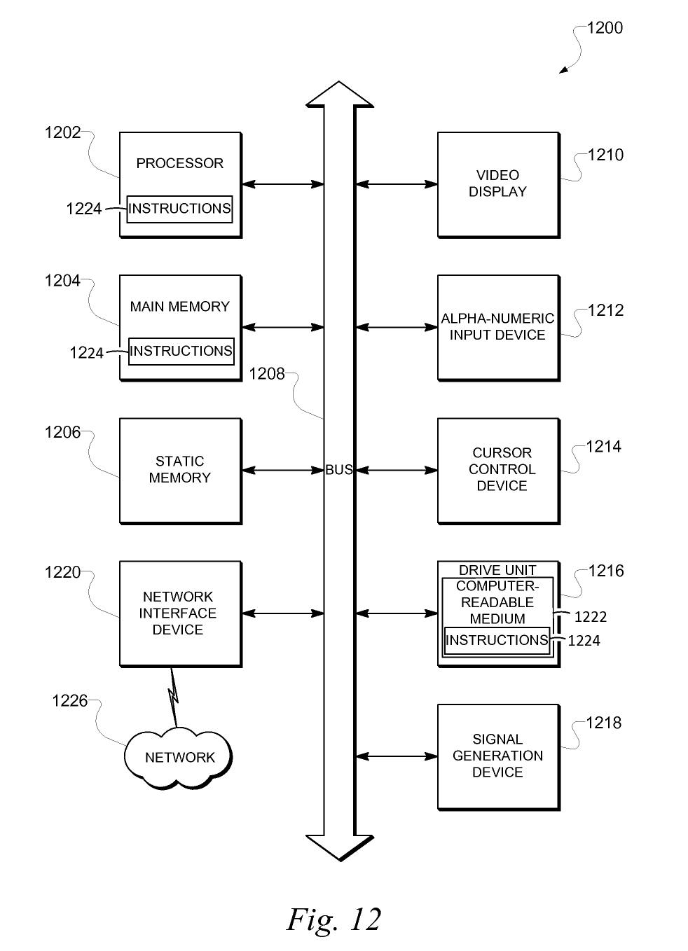

FIG. 12 is a block diagram of machine in the example form of a computer system 1200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
determining that a particular object has physically contacted a wireless access point device or is currently located within a predetermined distance of the wireless access point device;
activating a passive listening mode of the wireless access point device and detecting a wireless access probe request broadcast by a mobile device;
determining that the mobile device is the particular object, based on the wireless access probe request;
determining a media access control address associated with the mobile device, based on the wireless access probe request; and
identifying a user of the mobile device, based on the media access control address associated with the mobile device.

2. The method of claim 1, further comprising determining that the particular object has physically contacted the wireless access point device or is currently located within a predetermined distance of the wireless access point device, based on input from an accelerometer, gyroscope, motion detection sensor, or rangefinder sensor associated with the wireless access point device.

3. The method of claim 1, further comprising activating a low power passive listening mode of the wireless access point device,
wherein the wireless access point device is configured to detect wireless access probe requests from mobile devices located within a specific distance of the wireless access point device, responsive to the activation of the low power passive listening mode.

4. The method of claim 1, further comprising:
determining a proximity of the mobile device to the wireless access point device, based on a signal strength of the wireless access probe request;
confirming that the mobile device is the particular object, based on the determined proximity.

5. The method of claim 1, wherein the identifying comprises accessing media access control address information identifying a plurality of users and a corresponding plurality of media access control addresses.

6. The method of claim 1, further comprising:
accessing user action information describing a predefined action associated with the user; and
performing the predefined action associated with the user.

7. The method of claim 6, further comprising:
transmitting a notification message to the user, the notification message requesting user authorization to perform the predefined action; and
receiving a response indicating user authorization to perform the predefined action.

8. The method of claim 1, wherein the wireless access point device is associated with a lock mechanism.

9. The method of claim 8, further comprising:
determining, based on an access control list associated with the door lock mechanism, that the user is authorized to control the lock mechanism; and
transmitting a notification message to the user, the notification message requesting user authorization to activate or deactivate the lock mechanism.

10. The method of claim 9, further comprising:
receiving a response indicating user authorization to activate or deactivate the door lock mechanism; and
activating or deactivating the, based on the response.

11. The method of claim 1, wherein the wireless access point device is associated with a vending machine or point-of-sale terminal.

12. The method of claim 11, further comprising:
accessing user financial account information associated with the user; and
transmitting a notification message to the user, the notification message requesting user authorization to perform a transaction based on the user financial account information at the vending machine or point-of-sale terminal.

13. The method of claim 12, further comprising:
receiving a response indicating user authorization to perform the transaction based on the user financial account information at the vending machine or point-of-sale terminal; and
performing the transaction, based on the response.

14. The method of claim 1, wherein the wireless access point device is associated with any one of a kiosk and a computing device.

15. The method of claim 14, further comprising:
transmitting a notification message to the user, the notification message requesting user authorization to transfer information between the mobile device and any one of the kiosk and the computing device.

16. The method of claim 15, further comprising:
receiving a response indicating user authorization to transfer the information between the mobile device and any one of the kiosk and the computing device; and
transferring the information between the mobile device and any one of the kiosk and the computing device, based on the response.

17. The method of claim 14, further comprising:
accessing user history information or user preference information associated with the user; and
displaying personalized content on any one of the kiosk and the computing device, based on the user history information or user preference information.

18. The method of claim 1, wherein the mobile device does not include a near field communication (NFC) chip, NFC tag, radio frequency identification (RFID) chip, or RFID tag.

19. An apparatus comprising:
a determination module configured to:
determine that a particular object has physically contacted a wireless access point device or is currently located within a predetermined distance of the wireless access point device;
activate a passive listening mode of the wireless access point device and detect a wireless access probe request broadcast by a mobile device; and
determine that the mobile device is the particular object, based on the wireless access probe request; and
an identification module configured to:
determine a media access control address associated with the mobile device, based on the wireless access probe request; and
identify a user of the mobile device, based on the media access control address associated with the mobile device.

20. A non-transitory machine-readable storage medium having embodied thereon instructions executable by one or more machines to perform operations comprising:
determining that a particular object has physically contacted a wireless access point device or is currently located within a predetermined distance of the wireless access point device;
activating a passive listening mode of the wireless access point device and detecting a wireless access probe request broadcast by a mobile device;
determining that the mobile device is the particular object, based on the wireless access probe request;
determining a media access control address associated with the mobile device, based on the wireless access probe request; and
identifying a user of the mobile device, based on the media access control address associated with the mobile device.
